(19) United States
(12) Patent Application Publication
(10) Pub. No.: US 2020/0277487 A1
(43) Pub. Date: Sep. 3, 2020

(54) Thermoplastic Resin Composition and Molded Product Manufactured Therefrom

(71) Applicant: LOTTE CHEMICAL CORPORATION, Seoul (KR)

(72) Inventors: Cheon Seok YANG, Uiwang-si (KR); Yoen Kyoung KIM, Uiwang-si (KR); Seung Yong BAE, Uiwang-si (KR); Ju Sung KIM, Uiwang-si (KR); Kang Yeol PARK, Uiwang-si (KR)

(21) Appl. No.: 16/645,543

(22) PCT Filed: Aug. 30, 2018
(86) PCT No.: PCT/KR2018/010016

§ 371 Date: Mar. 9, 2020

(30) Foreign Application Priority Data
Oct. 26, 2017 (KR) 10-2017-0140219
Jun. 5, 2018 (KR) 10-2018-0064627

(51) Int. Cl. C08L 53/02

(52) U.S. Cl. CPC C08L 53/025; C08K 2003/0893

(57) ABSTRACT

A thermoplastic resin composition of the present invention comprises: approximately 100 parts by weight of a rubber-modified aromatic vinyl copolymer resin; approximately 0.1-1 parts by weight of zinc pyrithione; and approximately 0.1-10 parts by weight of zinc oxide, wherein the average particle size (D50) of the zinc oxide, measured by a particle size analyzer, is approximately 0.5-3 μm, and the size ratio (B/A) of peak A of the region of 370-390 nm and peak B of the region of 450-600 nm is approximately 0.01-1.0 during the measurement of photoluminescence. The thermoplastic resin composition has excellent weather resistance, antibacterial property, mechanical property and the like.

### TECHNICAL FIELD

The present invention relates to a thermoplastic resin composition and a molded product manufactured using the same. More particularly, the present invention relates to a thermoplastic resin composition which has good weather resistance, antibacterial properties, and mechanical properties, and a molded product manufactured using the same.

### BACKGROUND ART

Recently, with increasing interest in personal health and hygiene and increasing income level, there is increasing demand for thermoplastic resin products having antibacterial and hygienic functions. Accordingly, there is an increasing number of thermoplastic resin products subjected to antibacterial treatment to remove or inhibit bacterial growth on surfaces of household goods and electronic products. Therefore, development of a functional antibacterial material having stability and reliability (an antibacterial thermoplastic resin composition) is a very important challenge.

In order to prepare such an antibacterial thermoplastic resin composition, it is necessary to add antibacterial agents. Such antibacterial agents may be divided into organic antibacterial agents and inorganic antibacterial agents.

Organic antibacterial agents are sometimes toxic to humans, are effective only against certain bacteria, and are likely to decompose and lose antibacterial properties upon processing at high temperature, despite being relatively inexpensive and providing good antimicrobial effects even in small amounts. In addition, since the organic antibacterial agents can cause discoloration after processing and cannot have long-term antibacterial persistence due to dissolution-related problems, the range of organic antibacterial agents applicable to an antibacterial thermoplastic resin composition is extremely limited.

Inorganic antibacterial agents are antibacterial agents containing metal components, such as silver (Ag) and copper (Cu), and are widely used in preparation of antibacterial thermoplastic resin compositions (antibacterial resins) due to good thermal stability thereof. However, since the inorganic antibacterial agents need to be used in large amounts due to lower antibacterial activity than the organic antibacterial agents and have disadvantages of relatively high price, difficulty in uniform dispersion upon processing, and discoloration due to the metal components, the inorganic antibacterial agents are used in a limited range of applications.

Therefore, there is a need for a thermoplastic resin composition which has good properties in terms of weather resistance (discoloration resistance), antibacterial effects, and antibacterial persistence while providing antifungal properties.

The background technique of the present invention is disclosed in Korean Patent No. 10-0696385 and the like.

### DISCLOSURE

### Technical Problem

It is one aspect of the present invention is to provide a thermoplastic resin composition which has good weather resistance, antibacterial properties, and mechanical properties.

It is another aspect of the present invention to provide a molded product formed of the thermoplastic resin composition set forth above.

The above and other aspects of the present invention will become apparent from the detailed description of the following embodiments.

### Technical Solution

One aspect of the present invention relates to a thermoplastic resin composition. The thermoplastic resin composition includes: about 100 parts by weight of a rubber-modified aromatic vinyl copolymer resin; about 0.1 parts by weight to about 1 part by weight of zinc pyrithione; and about 0.1 parts by weight to about 10 parts by weight of zinc oxide, wherein the zinc oxide has an average particle diameter (D50) of about 0.5 μm to about 3 μm, as measured using a particle size analyzer, and a peak intensity ratio (B/A) of about 0.01 to about 1.0, where A indicates a peak in the wavelength range of 370 nm to 390 nm and B indicates a peak in the wavelength range of 450 nm to 600 nm in photoluminescence measurement.

In one embodiment, the zinc pyrithione and the zinc oxide may be present in a weight ratio (zinc pyrithione:zinc oxide) of about 1:2 to about 1:10.

In one embodiment, the rubber-modified aromatic vinyl copolymer resin may include a rubber-modified vinyl graft copolymer and an aromatic vinyl copolymer resin.

In one embodiment, the rubber-modified vinyl graft copolymer may be obtained by graft-polymerization of an aromatic vinyl monomer and a monomer copolymerizable with the aromatic vinyl monomer to a rubber polymer.

In one embodiment, the aromatic vinyl copolymer resin may be a polymer of an aromatic vinyl monomer and a monomer copolymerizable with the aromatic vinyl monomer.

In one embodiment, the zinc oxide may have a peak position degree (20) in the range of about 35° to about 37° and a crystallite size of about 1,000 Å to about 2,000 Å in X-ray diffraction (XRD) analysis, as calculated by Equation 1:

$$\text{Crystallite size} ( D ) = \frac{K λ}{βcosθ} \qquad [ Equation 1 ]$$

where K is a shape factor, λ is an X-ray wavelength, β is an FWHM value (degree) of an X-ray diffraction peak, and θ is a peak position degree.

In one embodiment, the zinc oxide may have a peak intensity ratio (B/A) of about 0.1 to about 1.0, where A indicates a peak in the wavelength range of 370 nm to 390 nm and B indicates a peak in the wavelength range of 450 nm to 600 nm in photoluminescence measurement.

In one embodiment, the zinc oxide may have an average particle diameter (D50) of about 0.5 μm to about 2 μm, as measured using a particle size analyzer.

In one embodiment, the zinc oxide may have a BET specific surface area of about 15 m²/g or less, as measured by a nitrogen gas adsorption method using a BET analyzer.

In one embodiment, the zinc oxide may have a BET specific surface area of about 1 m²/g to about 10 m²/g, as measured by a nitrogen gas adsorption method using a BET analyzer.

In one embodiment, the thermoplastic resin composition may have a color variation (ΔE) of about 15 or less, as calculated according to Equation 2 based on initial color values (L₀*, a₀*, b₀*) measured on an injection-molded specimen having a size of 50 mm×90 mm×2.5 mm using a colorimeter and color values (L₁*, a₁*, b₁*) of the specimen measured in the same manner as above after testing for 1,500 hours in accordance with ASTM D4459.

Color variation (ΔE)=\sqrt{(ΔL*)²+(Δa*)²+(Δb*)²} [Equation 2]

where ΔL* is a difference (L₁*-L₀*) between L* values before and after testing, Δa* is a difference (a₁*-a₀*) between a* values before and after testing, and Δb* is a difference (b₁*-b₀*) between b* values before and after testing.

In one embodiment, the thermoplastic resin composition may have an antibacterial activity of about 2 to about 7 against Staphylococcus aureus and an antibacterial activity of about 2 to about 7 against Escherichia coli, as calculated according to Equation 3 after inoculation of 5 cm×5 cm specimens with Staphylococcus aureus and Escherichia coli, respectively, and culturing under conditions of 35° C. and 90% RH for 24 hours in accordance with JIS Z 2801.

Antibacterial activity=log(M1/M2) [Equation 3]

where M1 is the number of bacteria as measured on a blank specimen after culturing for 24 hours and M2 is the number of bacteria as measured on each of the specimens of the thermoplastic resin composition after culturing for 24 hours.

Another aspect of the present invention relates to a molded product. The molded product is formed of the thermoplastic resin composition set forth above.

### Advantageous Effects

The present invention provides a thermoplastic resin composition which has good weather resistance, antibacterial properties, and mechanical properties, and a molded product formed of the same.

### BEST MODE

Hereinafter, exemplary embodiments of the present invention will be described in detail.

A thermoplastic resin composition according to the present invention includes: (A) a rubber-modified aromatic vinyl copolymer resin; (B) zinc pyrithione; and (C) zinc oxide.

(A) Rubber-Modified Aromatic Vinyl Copolymer Resin

The rubber-modified aromatic vinyl copolymer resin according to one embodiment of the present invention may include (A1) a rubber-modified vinyl graft copolymer and (A2) an aromatic vinyl copolymer resin.

(A1) Rubber-Modified Vinyl Graft Copolymer

The rubber-modified vinyl graft copolymer according to one embodiment of the present invention may be obtained by graft-copolymerization of an aromatic vinyl monomer and a monomer copolymerizable with the aromatic vinyl monomer to a rubber polymer.

In some embodiments, the rubber-modified vinyl graft copolymer may be obtained by adding the aromatic vinyl monomer and the monomer copolymerizable with the aromatic vinyl monomer to the rubber polymer, followed by polymerization. Here, the polymerization may be performed by any suitable polymerization method known in the art, such as emulsion polymerization, suspension polymerization, and mass polymerization.

In some embodiments, the rubber polymer may include diene rubbers, such as polybutadiene, poly(styrene-butadiene), and poly(acrylonitrile-butadiene), saturated rubbers obtained by adding hydrogen to the diene rubbers, isoprene rubbers, acrylic rubbers, such as polybutyl acrylate, and ethylene-propylene-diene terpolymer (EPDM). These may be used alone or as a mixture thereof. For example, the rubber polymer may include diene rubbers, specifically a butadiene rubber. The rubber polymer may be present in an amount of about 5 wt % to about 65 wt %, for example, about 10 wt % to about 60 wt %, specifically about 20 wt % to about 50 wt %, based on the total weight of the rubber-modified vinyl graft copolymer. Within this range, the thermoplastic resin composition can have good impact resistance and mechanical properties. In addition, the rubber polymer (rubber particles) may have an average (z-average) particle diameter of about 0.05 μm to about 6 μm, for example, about 0.15 μm to about 4 μm, specifically about 0.25 μm to about 3.5 μm. Within this range, the thermoplastic resin composition can have good properties in terms of impact resistance, appearance, and flame retardancy.

In some embodiments, the aromatic vinyl monomer is graft-copolymerizable to the rubber polymer and may include, for example, styrene, α-methyl styrene, β-methylstyrene, p-methyl styrene, p-t-butyl styrene, ethyl styrene, vinylxylene, monochlorostyrene, dichlorostyrene, dibromostyrene, and vinyl naphthalene, without being limited thereto. These may be used alone or as a mixture thereof. The aromatic vinyl monomer may be present in an amount of about 15 wt % to about 94 wt %, for example, about 20 wt % to about 80 wt %, specifically about 30 wt % to about 60 wt %, based on the total weight of the rubber-modified vinyl graft copolymer. Within this range, the thermoplastic resin composition can have good fatigue resistance, impact resistance, and mechanical properties.

In some embodiments, the monomer copolymerizable with the aromatic vinyl monomer may include, for example, vinyl cyanide compounds, such as acrylonitrile, methacrylonitrile, ethacrylonitrile, phenylacrylonitrile, α-chloroacrylonitrile, and fumaronitrile, (meth)acrylic acids and alkyl esters thereof, maleic anhydride, and N-substituted maleimide. These may be used alone or as a mixture thereof. Specifically, the monomer copolymerizable with the aromatic vinyl monomer may include acrylonitrile, methyl (meth)acrylate, and combinations thereof. The monomer copolymerizable with the aromatic vinyl monomer may be present in an amount of about 1 wt % to about 50 wt %, for example, about 5 wt % to about 45 wt %, specifically about 10 wt % to about 30 wt %, based on the total weight of the rubber-modified vinyl graft copolymer. Within this range, the thermoplastic resin composition can have good properties in terms of impact resistance, flowability, and appearance.

In some embodiments, examples of the rubber-modified vinyl graft copolymer may include a copolymer (g-ABS) obtained by grafting a styrene monomer as an aromatic vinyl compound and an acrylonitrile monomer as a vinyl cyanide compound to a butadiene rubber polymer and a copolymer (g-MBS) obtained by grafting a styrene monomer as an aromatic vinyl compound and methyl methacrylate as a monomer copolymerizable therewith to a butadiene rubber polymer, without being limited thereto.

In some embodiments, the rubber-modified vinyl graft copolymer may be present in an amount of about 10 wt % to about 40 wt %, for example, about 15 wt % to about 35 wt %, based on the total weight of the rubber-modified aromatic vinyl copolymer resin (A). Within this range, the thermoplastic resin composition can have good properties in terms of impact resistance and flowability (moldability).

(A2) Aromatic Vinyl Copolymer Resin

The aromatic vinyl copolymer resin according to one embodiment of the present invention may include an aromatic vinyl copolymer resin used in typical rubber-modified vinyl copolymer resins. For example, the aromatic vinyl copolymer resin may be a polymer of a monomer mixture including an aromatic vinyl monomer and a monomer copolymerizable with the aromatic vinyl monomer, such as a vinyl cyanide monomer.

In some embodiments, the aromatic vinyl copolymer resin may be obtained by mixing the aromatic vinyl monomer with the monomer copolymerizable with the aromatic vinyl monomer, followed by polymerization of the mixture. Here, the polymerization may be performed by any suitable polymerization method known in the art, such as emulsion polymerization, suspension polymerization, and mass polymerization.

In some embodiments, the aromatic vinyl monomer may include styrene, α-methyl styrene, β-methylstyrene, p-methyl styrene, p-t-butylstyrene, ethyl styrene, vinylxylene, monochlorostyrene, dichlorostyrene, dibromostyrene, and vinyl naphthalene, without being limited thereto. These may be used alone or as a mixture thereof. The aromatic vinyl monomer may be present in an amount of about 20 wt % to about 90 wt %, for example, about 30 wt % to about 80 wt %, based on the total weight of the aromatic vinyl copolymer resin. Within this range, the thermoplastic resin composition can have good properties in terms of impact resistance and flowability.

In some embodiments, the monomer copolymerizable with the aromatic vinyl monomer may include, for example, vinyl cyanide compounds, such as acrylonitrile, methacrylonitrile, ethacrylonitrile, phenylacrylonitrile, α-chloroacrylonitrile, and fumaronitrile, (meth)acrylic acids and alkyl esters thereof, maleic anhydride, and N-substituted maleimide. These may be used alone or as a mixture thereof. The monomer copolymerizable with the aromatic vinyl monomer may be present in an amount of about 10 wt % to about 80 wt %, for example, about 20 wt % to about 70 wt %, based on the total weight of the aromatic vinyl copolymer resin. Within this range, the thermoplastic resin composition can have good properties in terms of impact resistance and flowability.

In some embodiments, the aromatic vinyl copolymer resin may have a weight average molecular weight (Mw) of about 10,000 g/mol to about 300,000 g/mol, for example, about 15,000 g/mol to about 150,000 g/mol, as measured by gel permeation chromatography (GPC). Within this range, the thermoplastic resin composition can have good properties in terms of mechanical strength and moldability.

In some embodiments, the aromatic vinyl copolymer resin may be present in an amount of about 60 wt % to about 90 wt %, for example, about 65 wt % to about 85 wt %, based on the total weight of the rubber-modified aromatic vinyl copolymer resin (A). Within this range, the thermoplastic resin composition can have good properties in terms of impact resistance and flowability (moldability).

(B) Zinc Pyrithione

The zinc pyrithione according to the present invention serves to improve weather resistance of the thermoplastic resin composition along with the zinc oxide, and may include a compound represented by Formula 1:

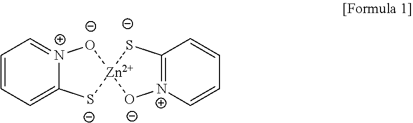

In some embodiments, the zinc pyrithione may be present in an amount of about 0.1 parts by weight to about 1 part by weight, for example, about 0.2 parts by weight to about 0.6 parts by weight, relative to about 100 parts by weight of the rubber-modified aromatic vinyl copolymer resin. If the amount of the zinc pyrithione is less than about 0.1 parts by weight relative to about 100 parts by weight of the rubber-modified aromatic vinyl copolymer resin, the thermoplastic resin composition can have poor weather resistance and antibacterial properties. If the amount of the zinc pyrithione exceeds about 1 part by weight relative to about 100 parts by weight of the rubber-modified aromatic vinyl copolymer resin, there can be a significant difference between initial colors of the thermoplastic resin and the thermoplastic resin composition.

(C) Zinc Oxide

The zinc oxide according to the present invention serves to improve weather resistance and antibacterial properties of the thermoplastic resin composition, and may have a peak intensity ratio (B/A) of about 0.01 to about 1.0, for example, about 0.1 to about 1.0, specifically about 0.2 to about 0.7, where A indicates a peak in the wavelength range of 370 nm to 390 nm and B indicates a peak in the wavelength range of 450 nm to 600 nm in photoluminescence measurement. If the peak intensity ratio (B/A) of the zinc oxide is less than about 0.01, the thermoplastic resin composition can have poor antibacterial properties. If the peak intensity ratio (B/A) of the zinc oxide exceeds about 1.0, there can be a significant difference between initial colors of the thermoplastic resin and the thermoplastic resin composition and the thermoplastic resin composition can have poor weather resistance.

In some embodiments, the zinc oxide may have various shapes, for example, a spherical shape, a plate shape, a rod shape, and combinations thereof. In addition, the zinc oxide may have an average particle diameter (D50) of about 0.5 μm to about 3 μm, for example, about 0.5 μm to about 2 μm, specifically about 0.9 μm to about 1.5 μm, as measured in a single particle state (not forming a secondary particle through agglomeration of particles) using a particle size analyzer (Laser Diffraction Particle Size Analyzer LS I3 320, Beckman Coulter Co., Ltd.). If the average particle diameter (D50) of the zinc oxide is less than about 0.5 μm or exceeds about 3 μm, the thermoplastic resin composition can have poor weather resistance.

In some embodiments, the zinc oxide may have a peak position degree (20) in the range of about 35° to about 37° and a crystallite size of about 1,000 Å to about 2,000 Å, for example, about 1,200 Å to about 1,800 Å, in X-ray diffraction (XRD) analysis, as calculated by Scherrer's equation (Equation 1) with reference to a measured FWHM value (full width at half maximum of a diffraction peak). Within this range, the thermoplastic resin composition can have good initial color, weather resistance (discoloration resistance), antibacterial properties, and balance between mechanical properties.

$$\text{Crystallite size} ( D ) = \frac{K λ}{βcosθ} \qquad [ Equation 1 ]$$

where K is a shape factor, λ is an X-ray wavelength, β is an FWHM value (degree) of an X-ray diffraction peak, and θ is a peak position degree.

In some embodiments, the zinc oxide may have a BET specific surface area of about 15 m²/g or less, for example, about 1 m²/g to about 10 m²/g, as measured by a nitrogen gas adsorption method using a BET analyzer (Surface Area and Porosity Analyzer ASAP 2020, Micromeritics Co., Ltd.), and a purity of about 99% or more. Within this range, the thermoplastic resin composition can have good discoloration resistance and mechanical properties.

In some embodiments, the zinc oxide may be prepared by melting metallic zinc in a reactor, heating the molten zinc to about 850° C. to about 1,000° C., for example, about 900° C. to about 950° C., to vaporize the molten zinc, injecting oxygen gas into the reactor, cooling the reactor to about 20° C. to about 30° C., and heating the reactor to about 400° C. to about 900° C., for example, 500° C. to about 800° C., for about 30 minutes to about 150 minutes, for example, about 60 minutes to about 120 minutes.

In some embodiments, the zinc oxide may be present in an amount of about 0.1 parts by weight to about 10 parts by weight, for example, about 1 part by weight to about 5 parts by weight, relative to about 100 parts by weight of the rubber-modified aromatic vinyl copolymer resin. If the amount of the zinc oxide is less than about 0.1 parts by weight relative to about 100 parts by weight of the rubber-modified aromatic vinyl copolymer resin, the thermoplastic resin composition can have poor weather resistance and antibacterial properties. If the amount of the zinc oxide exceeds about 10 parts by weight, the thermoplastic resin composition can have poor mechanical properties.

In some embodiments, the zinc pyrithione and the zinc oxide may be present in a weight ratio (zinc pyrithione:zinc oxide) of about 1:2 to about 1:10, for example, about 1:2 to about 1:8. Within this range, the thermoplastic resin composition can have better weather resistance, antibacterial properties, and mechanical properties.

The thermoplastic resin composition according to the present invention may further include additives used in typical thermoplastic resin compositions. Examples of the additives may include flame retardants, fillers, antioxidants, anti-dripping agents, lubricants, release agents, nucleating agents, antistatic agents, pigments, dyes, and combinations thereof, without being limited thereto. When used in the thermoplastic resin composition, the additives may be present in an amount of about 0.001 parts by weight to about 40 parts by weight, for example, about 0.1 parts by weight to about 10 parts by weight, relative to about 100 parts by weight of the thermoplastic resin (the rubber-modified aromatic vinyl copolymer resin).

The thermoplastic resin composition according to the present invention may be prepared in pellet form by mixing the aforementioned components, followed by melt extrusion in a typical twin-screw extruder at about 200° C. to about 280° C., for example, about 220° C. to about 250° C.

In some embodiments, the thermoplastic resin composition may have a color variation (ΔE) of about 15 or less, for example, about 5 to about 11, as calculated according to Equation 2 based on initial color values (L₀*, a₀*, b₀*) measured on an injection-molded specimen having a size of 50 mm×90 mm×2.5 mm using a colorimeter and color values (L₁*, a₁*, b₁*) of the specimen measured in the same manner as above after testing for 1,500 hours in accordance with ASTM D4459.

Color variation (ΔE)=\sqrt{(ΔL*)²+(Δa*)²+(Δb*)²} [Equation 2]

where ΔL* is a difference (L₁*-L₀*) between L* values before and after testing, Δa* is a difference (a₁*-a₀*) between a* values before and after testing, and Δb* is a difference (b₁*-b₀*) between b* values before and after testing.

Here, Δa* may range from about 1.0 to about 1.5. Within this range of Δa*, the thermoplastic resin composition can have good properties in terms of weather resistance (discoloration resistance) and color.

In some embodiments, the thermoplastic resin composition has an antibacterial effect against various bacteria such as Staphylococcus aureus, Escherichia coli, Bacillus subtilis, Pseudomonas aeruginosa, Salmonella, Pneumococcus, and methicillin-resistant Staphylococcus Aureus (MRSA), and may have an antibacterial activity of about 2 to about 7, for example, about 3 to about 6.3, against Staphylococcus aureus and an antibacterial activity of about 2 to about 7, for example, about 3 to about 6.3, against Escherichia coli, as calculated according to Equation 3 after inoculation of 5 cm×5 cm specimens with Staphylococcus aureus and Escherichia coli, respectively, and culturing under conditions of 35° C. and 90% RH for 24 hours in accordance with JIS Z 2801.

Antibacterial activity=log(M1/M2) [Equation 3]

where M1 is the number of bacteria as measured on a blank specimen after culturing for 24 hours and M2 is the number of bacteria as measured on each of the specimens of the thermoplastic resin composition after culturing for 24 hours.

Here, the “blank specimen” refers to a control specimen for comparison with a test specimen (specimen of the thermoplastic resin composition). Specifically, the blank specimen is prepared by inoculating bacteria on an empty petri dish, which is suitable for checking whether the inoculated bacteria grow normally, followed by culturing for 24 hours under the same conditions as the test specimen. Antibacterial performance of the test specimen is evaluated based on comparison of the number of cultured bacteria between the blank specimen and the test specimen. Here, the “number of cultured bacteria” may be determined through a process in which each specimen is inoculated with the bacteria, followed by culturing for 24 hours, and then an inoculation solution of the bacteria is recovered and diluted, followed by growing the bacteria to a colony on a culture dish. When population of the colony is too large to count, the number of cultured bacteria may be determined by dividing the colony divided into multiple sectors, measuring the population size of one sector, and converting the measured value into total population.

In some embodiments, the thermoplastic resin composition may have a notched Izod impact strength of about 19 kgf·cm/cm to about 23 kgf·cm/cm, as measured on a ⅛″ thick specimen in accordance with ASTM D256.

In some embodiments, the thermoplastic resin composition may have an initial color variation (ΔE2) of about 1.5 or less, for example, about 0.1 to about 1.4, where the initial color variation indicates a difference in initial color between the thermoplastic resin and the thermoplastic resin composition and is calculated according to Equation 4 based on initial color values (L₂*, a₂*, b₂*) measured on a 50 mm×90 mm×2.5 mm injection-molded specimen of the thermoplastic resin and initial color values (L₀*, a₀*, b₀*) of a 50 mm×90 mm×2.5 mm injection-molded specimen of each of thermoplastic resin compositions prepared in Examples. Within this range, there can be no significant difference between initial colors between the thermoplastic resin and the thermoplastic resin composition, whereby the thermoplastic resin composition can have good color quality.

Initial color variation (ΔE2)=\sqrt{(ΔL*)²+(Δa*)²+(Δb*)²} [Equation 4]

where ΔL* is a difference (L₂*-L₀*) between initial L* values of the specimen of the thermoplastic resin and the specimen of the thermoplastic resin composition, Δa* is a difference (a₂*-a₀*) between initial a* values of the specimen of the thermoplastic resin and the specimen of the thermoplastic resin composition, and Δb* is a difference (b₂*-b₀*) between initial b* values of the specimen of the thermoplastic resin and the specimen of the thermoplastic resin composition.

A molded product according to the present invention is formed of the thermoplastic resin composition set forth above. The thermoplastic resin composition may be prepared in pellet form. The prepared pellets may be produced into various molded products (articles) by various molding methods such as injection molding, extrusion, vacuum molding, and casting. These molding methods are well known to those skilled in the art. The molded product has good weather resistance, antibacterial properties, impact resistance, flowability (moldability), and balance therebetween and thus can be advantageously used as an exterior material or material for products which are frequently touched by the human body and thus require antibacterial properties.

### MODE FOR INVENTION

Next, the present invention will be described in more detail with reference to some examples. It should be understood that these examples are provided for illustration only and are not to be in any way construed as limiting the present invention.

### Example

Details of components used in Examples and Comparative Examples are as follows:

(A) Rubber-Modified Aromatic Vinyl Copolymer Resin

A rubber-modified aromatic vinyl copolymer resin including 28 wt % of (A1) a rubber-modified vinyl graft copolymer and 72 wt % of (A2) an aromatic vinyl copolymer resin was used.

(A1) Rubber-Modified Vinyl Graft Copolymer

A g-ABS copolymer obtained by graft-copolymerization of 55 wt % of styrene and acrylonitrile (weight ratio: 75/25) to 45 wt % of polybutadiene rubber (PBR, z-average particle diameter: 310 nm) was used.

(A2) Aromatic Vinyl Copolymer Resin

A SAN resin (weight average molecular weight: 130,000 g/mol) obtained by polymerization of 68 wt % of styrene and 32 wt % of acrylonitrile was used.

(B) Zinc Pyrithione

Zinc pyrithione (Wako Pure Chemicals Industries Ltd.) was used.

(C) Zinc Oxide

(C1) Zinc Oxide

Metallic zinc was melted in a reactor, followed by heating to 900° C. to vaporize the molten zinc, and then oxygen gas was injected into the reactor, followed by cooling to room temperature (25° C.) to obtain an intermediate. Then, the intermediate was subjected to heat treatment at 750° C. for 150 minutes, followed by cooling to room temperature (25° C.), thereby preparing zinc oxide (C1).

(C2) Zinc oxide (Manufacturer: Ristecbiz Co., Ltd., product name: RZ-950) was used.

(C3) Zinc oxide (Manufacture: Hanil Chemical Ind Co., Ltd., product name: TE30) was used.

For each of the zinc oxides C1, C2, C3, average particle diameter, BET surface area, purity, peak intensity ratio (B/A) of peak B in the wavelength range of 450 nm to 600 nm to peak A in the wavelength range of 370 nm to 390 nm in photoluminescence measurement, and crystallite size were measured. Results are shown in Table 1.

TABLE 1

| | (C1) | (C2) | (C3) |
|---|---|---|---|
| Average particle | 1.2 | 0.890 | 3.7 |
| diameter (μm) | | | |
| BET surface area | 4 | 15 | 14 |
| (m²/g) | | | |
| Purity (%) | 99 | 97 | 97 |
| PL peak intensity | 0.28 | 9.8 | 9.5 |
| ratio (B/A) | | | |
| Crystallite size | 1417 | 503 | 489 |
| (Å) | | | |

Property Evaluation

(1) Average particle diameter (unit: μm): Average particle diameter (volume average) was measured using a particle size analyzer (Laser Diffraction Particle Size Analyzer LS I3 320, Beckman Coulter Co., Ltd.).

(2) BET surface area (unit: m²/g): BET surface area was measured by a nitrogen gas adsorption method using a BET analyzer (Surface Area and Porosity Analyzer ASAP 2020, Micromeritics Co., Ltd.).

(3) Purity (unit: %): Purity was measured by thermogravimetric analysis (TGA) based on the weight of remaining material at 800° C.

(4) PL peak intensity ratio (B/A): Spectrum emitted upon irradiation of a specimen using a He—Cd laser (KIMMON, 30 mW) at a wavelength of 325 nm at room temperature was detected by a CCD detector in a photoluminescence measurement method, in which the CCD detector was maintained at −70° C. A peak intensity ratio (B/A) of peak B in the wavelength range of 450 nm to 600 nm to peak A in the wavelength range of 370 nm to 390 nm was measured. Here, an injection molded specimen was irradiated with laser beams without separate treatment upon PL analysis, and zinc oxide powder was compressed in a pelletizer having a diameter of 6 mm to prepare a flat specimen.

(5) Crystallite size (unit: Å): Crystallite size was measured using a high-resolution X-ray diffractometer (PRO-MRD, X'pert Inc.) at a peak position degree (20) in the range of 35° to 37° and calculated by Scherrer's equation (Equation 1) with reference to a measured FWHM value (full width at half maximum of a diffraction peak). Here, both a powder form and an injection molded specimen could be measured. For more accurate analysis, the injection molded specimen was subjected to heat treatment in air at 600° C. for 2 hours to remove a polymer resin therefrom before XRD analysis.

$$\text{Crystallite size} ( D ) = \frac{K λ}{βcosθ} \qquad [ Equation 1 ]$$

where K is a shape factor, λ is an X-ray wavelength, β is an FWHM value (degree) of an X-ray diffraction peak, and θ is a peak position degree.

### Examples 1 to 4 and Comparative Examples 1 to 10

The aforementioned components were mixed in amounts as listed in Tables 2 and 3, followed by extrusion at 230° C., thereby preparing a thermoplastic resin composition in pellet form. Here, extrusion was performed using a twin-screw extruder (L/D: 36, Φ: 45 mm). The prepared pellets were dried at 80° C. for 4 hours or more and then subjected to injection molding using a 6 oz. injection machine (molding temperature: 230° C., mold temperature: 60° C.), thereby preparing a specimen. The prepared specimen was evaluated as to the following properties. Results are shown in Tables 2 and 3.

Property Evaluation

(1) Weather resistance (color variation (ΔE)): For determination of color variation, initial color values L₀*, a₀*, b₀* were measured on an injection molded specimen having a size of 50 mm×90 mm×2.5 mm using a colorimeter (KONICA MINOLTA CM-3700A), followed by testing for 1,500 hours in accordance with ASTM D4459, and then color values L₁*, a₁*, b₁* of the specimen were measured in the same manner as above. Thereafter, color variation (ΔE) was calculated according to Equation 2:

Color variation (ΔE)=\sqrt{(ΔL*)²+(Δa*)²+(Δb*)²} [Equation 2]

where ΔL* is a difference (L₁*-L₀*) between L* values before and after testing, Δa* is a difference (a₁*-a₀*) between a* values before and after testing, and Δb* is a difference (b₁*-b₀*) between b* values before and after testing.

(2) Antibacterial activity: In accordance with JIS Z 2801, 5 cm×5 cm specimens were inoculated with Staphylococcus aureus and Escherichia coli, respectively, and then subjected to culturing under conditions of 35° C. and 90% RH for 24 hours, followed by calculation of antibacterial activity according to Equation 3:

Antibacterial activity=log(M1/M2) [Equation 3]

where M1 is the number of bacteria as measured on a blank specimen after culturing for 24 hours and M2 is the number of bacteria as measured on each of the specimens after culturing for 24 hours.

(3) Impact resistance (Notched Izod impact strength (unit: kgf·cm/cm)): Notched Izod impact strength was measured on a ⅛″ thick Izod specimen in accordance with ASTM D256.

(4) Color (difference between initial colors of thermoplastic resin and thermoplastic resin composition (ΔE2)): For evaluation of color, initial color values Lz*, az*, bz* were measured on a 50 mm×90 mm×2.5 mm injection molded specimen of a thermoplastic resin (Comparative Example 1) using a colorimeter (KONICA MINOLTA CM-3700A) and initial color values L₀*, a₀*, b₀* were measured on a 50 mm×90 mm×2.5 mm injection molded specimen of each of the thermoplastic resin compositions prepared in Examples and Comparative Examples using a colorimeter (KONICA MINOLTA CM-3700A). Thereafter, an initial color variation (ΔE2) was calculated according to Equation 4:

Initial color variation (ΔE2)=\sqrt{(ΔL*)²+(Δa*)²+(Δb*)²} [Equation 4]

where ΔL* is a difference (L₂*-L₀*) between initial L* values of the specimen of the thermoplastic resin and the specimen of the thermoplastic resin composition, Δa* is a difference (a₂*-a₀*) between initial a* values of the specimen of the thermoplastic resin and the specimen of the thermoplastic resin composition, and Δb* is a difference (b₁*-b₀*) between initial b* values of the specimen of the thermoplastic resin and the specimen of the thermoplastic resin composition.

TABLE 2

Example

| | 1 | 2 | 3 | 4 |
|---|---|---|---|---|
| (A) (parts by weight) | 100 | 100 | 100 | 100 |
| (B) (parts by weight) | 0.2 | 0.4 | 0.6 | 0.6 |
| (C1) (parts by weight) | 1.5 | 1.5 | 1.5 | 4.8 |
| (C2) (parts by weight) | — | — | — | — |
| (C3) (parts by weight) | — | — | — | — |
| Weather resistance (ΔE) | 9.2 | 9.4 | 8.9 | 8.1 |
| Antibacterial activity | 2 | 3.2 | 6.3 | 6.3 |
| (Escherichia coli) | | | | |
| Antibacterial activity | 2.1 | 3 | 4.6 | 4.6 |
| (Staphylococcus aureus) | | | | |
| Notched Izod impact | 21 | 22 | 21.2 | 19.3 |
| strength | | | | |
| Difference in initial color | 0.6 | 1 | 1.4 | 1.1 |
| (ΔE2) | | | | |

TABLE 3

| | Comparative Example | | | | | | | | | |
|---|---|---|---|---|---|---|---|---|---|---|
| | 1 | 2 | 3 | 4 | 5 | 6 | 7 | 8 | 9 | 10 |
| (A) (parts by weight) | 100 | 100 | 100 | 100 | 100 | 100 | 100 | 100 | 100 | 100 |
| (B) (parts by weight) | — | 0.6 | 1 | — | 0.6 | 0.6 | 1.2 | 0.05 | 0.6 | 0.6 |
| (C1) (parts by weight) | — | — | — | 6 | — | — | 1.5 | 1.5 | — | — |
| (C2) (parts by weight) | — | — | — | — | 1 | 1.5 | — | — | — | — |
| (C3) (parts by weight) | — | — | — | — | — | — | — | — | 1 | 1.5 |
| Weather resistance (ΔE) | 17.5 | 16.9 | 15.9 | 11.1 | 16.3 | 16.2 | 9.1 | 13.3 | 17.1 | 16.9 |
| Antibacterial activity | 0.2 | 3.6 | 6.3 | 6.3 | 3.8 | 4 | 6.3 | 0.8 | 3.6 | 4.1 |
| (Escherichia coli) | | | | | | | | | | |
| Antibacterial activity | 0.1 | 3 | 4.6 | 4.6 | 3.1 | 3.3 | 4.6 | 0.7 | 3.1 | 3.5 |
| (Staphylococcus aureus) | | | | | | | | | | |
| Notched Izod impact | 20.1 | 20.9 | 20.1 | 17.0 | 21.5 | 21.4 | 21.2 | 21.1 | 20.8 | 19.6 |
| strength | | | | | | | | | | |
| Difference in initial color | 0 | 1.7 | 3.5 | 1.4 | 0.4 | 0.5 | 4.1 | 0.3 | 0.3 | 0.5 |
| (ΔE2) | | | | | | | | | | |

From the above results, it can be seen that the thermoplastic resin composition according to the present invention had good weather resistance (color variation (ΔE)), antibacterial properties (antibacterial activity), mechanical properties (notched Izod impact strength (impact resistance)), and color (initial core variation, ΔE2).

Conversely, the thermoplastic resin composition of Comparative Example 1, free from zinc pyrithione and zinc oxide, had very poor weather resistance and antibacterial properties. In addition, the thermoplastic resin compositions of Comparative Examples 2 and 3, free from zinc oxide, had poor weather resistance and antibacterial properties, and there was a large difference in initial color between the thermoplastic resin (Comparative Example 1) and each of the thermoplastic resin compositions of Comparative Examples 2 and 3, wherein the difference became larger with increasing amount of the zinc pyrithione. In addition, the thermoplastic resin composition of Comparative Example 4, free from zinc pyrithione, exhibited relatively poor weather resistance, antibacterial properties, and mechanical properties, as compared with the thermoplastic resin compositions of Examples, the thermoplastic resin compositions of Comparative Examples 5 and 6, using the zinc oxide (C2) instead of the zinc oxide (C1) according to the present invention, had very poor weather resistance, the thermoplastic resin composition of Comparative Example 7, using zinc pyrithione in an amount exceeding the range according to the present invention, had a severe initial color variation and thus exhibited poor appearance characteristics, and the thermoplastic resin composition of Comparative Example 8, using zinc pyrithione in an amount less than the range according to the present invention, had poor weather resistance and antibacterial properties. Further, the thermoplastic resin compositions of Comparative Examples 8 and 9, using the zinc oxide (C3) instead of the zinc oxide (C1) according to the present invention, had very poor weather resistance.

It should be understood that various modifications, changes, alterations, and equivalent embodiments can be made by those skilled in the art without departing from the spirit and scope of the invention.

1. A thermoplastic resin composition comprising:
about 100 parts by weight of a rubber-modified aromatic vinyl copolymer resin;
about 0.1 parts by weight to about 1 part by weight of zinc pyrithione; and
about 0.1 parts by weight to about 10 parts by weight of zinc oxide,
wherein the zinc oxide has an average particle diameter (D50) of about 0.5 μm to about 3 μm, as measured using a particle size analyzer, and a peak intensity ratio (B/A) of about 0.01 to about 1.0, where A indicates a peak in the wavelength range of 370 nm to 390 nm and B indicates a peak in the wavelength range of 450 nm to 600 nm in photoluminescence measurement.

2. The thermoplastic resin composition according to claim 1, wherein the zinc pyrithione and the zinc oxide are present in a weight ratio (zinc pyrithione:zinc oxide) of about 1:2 to about 1:10.

3. The thermoplastic resin composition according to claim 1, wherein the rubber-modified aromatic vinyl copolymer resin comprises a rubber-modified vinyl graft copolymer and an aromatic vinyl copolymer resin.

4. The thermoplastic resin composition according to claim 3, wherein the rubber-modified vinyl graft copolymer is obtained by graft-polymerization of an aromatic vinyl monomer and a monomer copolymerizable with the aromatic vinyl monomer to a rubber polymer.

5. The thermoplastic resin composition according to claim 3, wherein the aromatic vinyl copolymer resin is a polymer of an aromatic vinyl monomer and a monomer copolymerizable with the aromatic vinyl monomer.

6. The thermoplastic resin composition according to claim 1, wherein the zinc oxide has a peak position degree (20) in the range of about 35° to about 37° and a crystallite size of about 1,000 Å to about 2,000 Å in X-ray diffraction (XRD) analysis, as calculated by Equation 1:
$$\text{Crystallite size} ( D ) = \frac{K λ}{βcosθ} ,$$
where K is a shape factor, λ is an X-ray wavelength, β is an FWHM value (degree) of an X-ray diffraction peak, and θ is a peak position degree.

7. The thermoplastic resin composition according to claim 1, wherein the zinc oxide has a peak intensity ratio (B/A) of about 0.1 to about 1.0, where A indicates a peak in the wavelength range of 370 nm to 390 nm and B indicates a peak in the wavelength range of 450 nm to 600 nm in photoluminescence measurement.

8. The thermoplastic resin composition according to claim 1, wherein the zinc oxide has an average particle diameter (D50) of about 0.5 μm to about 2 μm, as measured using a particle size analyzer.

9. The thermoplastic resin composition according to claim 1, wherein the zinc oxide has a BET specific surface area of about 15 m²/g or less, as measured by a nitrogen gas adsorption method using a BET analyzer.

10. The thermoplastic resin composition according to claim 1, wherein the zinc oxide has a BET specific surface area of about 1 m²/g to about 10 m²/g, as measured by a nitrogen gas adsorption method using a BET analyzer.

11. The thermoplastic resin composition according to claim 1, wherein the thermoplastic resin composition has a color variation (ΔE) of about 15 or less, as calculated according to Equation 2 based on initial color values (L₀*, a₀*, b₀*) measured on an injection-molded specimen having a size of 50 mm×90 mm×2.5 mm using a colorimeter and color values (L₁*, a₁*, b₁*) of the specimen measured in the same manner as above after testing for 1,500 hours in accordance with ASTM D4459:
Color variation (ΔE)=\sqrt{(ΔL*)²+(Δa*)²+(Δb*)²} [Equation 2]
where ΔL* is a difference (L₁*-L₀*) between L* values before and after testing, Δa* is a difference (a₁*-a₀*) between a* values before and after testing, and Δb* is a difference (b₁*-b₀*) between b* values before and after testing.

12. The thermoplastic resin composition according to claim 1, wherein the thermoplastic resin composition has an antibacterial activity of about 2 to about 7 against Staphylococcus aureus and an antibacterial activity of about 2 to about 7 against Escherichia coli, as calculated according to Equation 3 after inoculation of 5 cm×5 cm specimens with Staphylococcus aureus and Escherichia coli, respectively, and culturing under conditions of 35° C. and 90% RH for 24 hours in accordance with JIS Z 2801:
Antibacterial activity=log(M1/M2), [Equation 3]
where M1 is the number of bacteria as measured on a blank specimen after culturing for 24 hours and M2 is the number of bacteria as measured on each of the specimens of the thermoplastic resin composition after culturing for 24 hours.

13. A molded product formed of the thermoplastic resin composition according to claim 1.
